(19) United States
(12) Patent Application Publication
(10) Pub. No.: US 2019/0362359 A1
(43) Pub. Date: Nov. 28, 2019

(54) A SYSTEM FOR PERSON AUTHENTICATION

(71) Applicant: TURKCELL TEKNOLOJI ARASTIRMA VE GELISTIRME ANONIM SIRKETI, ISTANBUL (TR)

(72) Inventors: Mehmet ÖZTÜRK, Maltepe/Istanbul (TR); Emrah KARADERE, Gebze/Kocaeli (TR); Ay?e Hantan SARI, Maltepe/Istanbul (TR)

(73) Assignee: TURKCELL TEKNOLOJI ARASTIRMA VE GELISTIRME ANONIM SIRKETI, ISTANBUL (TR)

(21) Appl. No.: 16/472,408

(22) PCT Filed: Dec. 21, 2017
(86) PCT No.: PCT/TR2017/000144

§ 371 Date: Jun. 21, 2019

(30) Foreign Application Priority Data
Dec. 22, 2016 (TR) 2016/19268
Dec. 30, 2016 (TR) 2016/20316
Dec. 30, 2016 (TR) 2016/20324

(51) Int. Cl. G06Q 20/40; H04L 29/06; H04W 12/06; G06K 9/00

(52) U.S. Cl. CPC G06Q 20/40145; H04L 63/0861; H04L 63/0884; G06K 9/00892; G06K 9/00087; G06K 9/00617; G06K 9/00288; H04W 12/06

(57) ABSTRACT

The present invention relates to a system for enabling persons who are or are not subscribers of institutions making financial transaction to realize person authentication by means of fingerprint and/or retina information and/or face detection in order to carry out transaction over financial institution. The inventive system consists of mobile device, financial institution unit, identity authentication unit and authentication server.

### TECHNICAL FIELD

The present invention relates to a system for enabling persons who are or are not subscribers of institutions making financial transaction to realize person authentication by means of fingerprint and/or retina information and/or face detection in order to carry out transaction over financial institution.

### BACKGROUND OF THE INVENTION

Today, institutions carrying out financial transactions such as banks have to perform person authentication in order to realize transactions of a person. The cases wherein person authentication remains incapable pave the way for malicious uses.

In common usage in the state of the art, persons use branches, Internet services and ATM's (Automatic Teller Machine) of the related institution in order to carry out financial transaction. Persons present their identity document and identity information in order to make transaction in branches, use different authentication methods together with password determined while using Interact services. A large part of the methods in the state of the art are presented for the financial institution's own registered customers. Therefore, a system whereby persons can realize authentication through the use of personal and inimitable fingerprint and/or retina information and/or face detection in order that they cart carry out transaction over any financial institution whereto they are registered or not.

The Chinese patent document no. CN105262731, an application in the state of the art, discloses a system for performing identity information verification of persons by means of registered fingerprint.

The Chinese patent document no. CN104992099, another application in the state of the art, discloses a system for reading and registering a person's fingerprint by means of a fingerprint sensor located on a mobile device.

The Chinese patent document no. CN203366349, another application in the state of the art, discloses a system related to a bank client identification. The said system consists of an information collection terminal and an identification device, in the system, client introduces himself/herself to the system by means of various apparatus (such as HD camera, fingerprint reader and microphone) in his/her mobile device. The data received from the customer's mobile device is compared with the information located in the bank server.

The Chinese patent document no. CN101901351, another application in the state of the art, discloses a system consisting of iris and face recognition transactions with hierarchical structure. In the said system, there is recognition step after registration step. Both face and iris image processing technique are used in the registration step. The obtained data (eye and face data) are compared with the data which belong to the user located in the database in the recognition step in the system.

### SUMMARY OF THE INVENTION

An objective of the present invention is to realize a system for enabling authentication of persons' identity information by using fingerprint and/or retina information and/or face recognition.

Another objective of the present invention is to realize a system for enabling financial institutions to realize a fingerprint and/or retina information and/or face recognition authentication independent from institutions without keeping records of persons' fingerprint and/or retina information and/or face recognition information.

### DETAILED DESCRIPTION OF THE INVENTION

“A System for Person Authentication” realized to fulfill the objectives of the present invention is shown in the figure attached, in which:

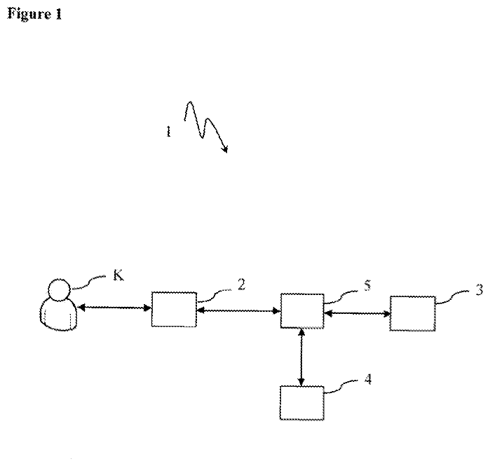

FIG. 1 is a schematic block diagram of the inventive system.

The components illustrated in the figure are individually numbered, where the numbers refer to the following:

1. System

2. Mobile device

3. Financial institution unit

4. Identity authentication unit

5. Authentication server

K: User

Thee inventive system (1) providing person authentication comprises:
at least one mobile device (2) with which the user (K) interacts, whereon it can run at least one application and which is configured such that the user (K) can read fingerprint and/or read retina information and/or identity lineaments;
at least one financial institution unit (3) which manages the financial institution transactions carried out over Internet, realizes the user (K) authentication, receives the transaction requests of the user (K) who are authenticated, and carries out the transactions in accordance with the related request;
at least one identity authentication unit (4) which is managed by a competent authority and records the user's fingerprint and/or retina information and/or lineaments in association with their identity information;
at least one authentication server (5) which receives the user (K) requests over the mobile device (2) by means of a data network, transmits the identity information transmitted by the user (K) and the fingerprint read and/or retina information and/or lineaments detected by the mobile device (2) to the identity authentication unit (4) and enables the user (K) to carry out transaction by transmitting the received answer to the financial institution unit (3) (FIG. 1).

The mobile device (2) included in the inventive system (1) comprises an interface which enables the user (K) to interact. The interface comprised by the mobile device (2) enables the user (K) to display the Internet service belonging to the financial institution, to create inputs and to display the data transmitted by the authentication server (5). The mobile device (2) is a unit which enables the user (K) to input his/her identity information and can read the user's (K) fingerprint and/or retina information acid/or detect his/her lineaments in the event that the authentication server (5) demands. In one embodiment of the invention, the mobile device (2) has a structure such that it can read the fingerprint in the event that the user (K) presses his/her finger to a certain area as hardware. In another embodiment of the invention, the mobile device (2) has a structure such that it can read the retina information in the event that the user (K) approaches his/her eye to a certain area as hardware. In another embodiment of the invention, the mobile device (2) has a structure such that lineaments of a user (K) can he detected by means of an image reception member such as a camera as hardware.

The financial institution unit (3) included in the inventive system (1) is a unit which realizes management of services provided to users over Internet by the financial institution. The financial institution unit (3) carries out transactions about the Internet service used by the user (K) over the mobile device (2) by means of the authentication server (5). The financial institution unit (3) receives the transaction demands that the user (K) wants to realize over the authentication server (5) in the H) event that the authentication server (5) notifies that the user (K) is authenticated. The financial institution unit (3), which carries out the transactions in accordance with the transaction demands received, transmits the transaction results to the authentication server (5) so that it notifies them to the user. In one embodiment of the invention, the financial institution unit (3) is in communication with an authentication server (5) providing only its own Internet service.

The identity authentication unit (4) included in the inventive system (1) is a unit which records fingerprints and/or retina information and/or lineaments and identity information of the users under a certain authority by a higher authority whereon the financial institutions depend. In the preferred embodiment of the invention, the higher authority of financial institutions is a management unit that is assigned by the state whereon the financial institutions depend by law for the related institutions. The identity authentication unit (4) is a unit wherein the user's fingerprints and/or retina information and/or lineaments are recorded upon being associated with their identity information. The identity authentication unit (4) runs query among the user (K) identity information that it records for the user (K) identity information transmitted in the event that the authentication server (5) transmits the identity information that it receives from the user (K) and the user's (K) fingerprint information and/or retina information and/or information about his/her lineament read by means the mobile device (2). The identity authentication unit (4) compares the recorded fingerprint information and/or the retina information and/or the information about his/her lineament related to the matched user (K) identity information recorded by itself with the fingerprint information and/or the retina information and/or the information about his/her lineament transmitted by the user (K) via the mobile device (2), in the event that match is provided. The identity authentication unit (4) transmits the in that the user (K) is authenticated to the authentication server (5), in the event that the fingerprint information and/or the retina information and/or the information about the lineament match as a result of comparison.

The authentication server (5) included in the inventive system (1) is in communication with the mobile device (2) over a data network. The authentication server (5) is a unit which provides Internet service of the financial institution. In the event that the user (K) sends transaction request by means of the mobile device (2), the authentication server (5) demands the user's (K) identity information over the application interface of the financial institution running on the mobile device (2) and the fingerprint information and/or the retina information and/or the information about the lineament by means of the fingerprint reading feature and/or the retina information reading feature and/or the lineaments detection feature provided by the mobile device (2). In the event that the user (K) inputs the demanded information, the authentication server (5) transmits the identity and fingerprint information and/or the retina information and/or the information about the lineament that it receives from the user (K), to the identity authentication unit (4). In the preferred embodiment of the invention, the authentication server (5) provides integration with the identity authentication unit (4) by using a secure protocol. The authentication server (5) informs the user (K) over the mobile device (2) and transmits the interface information that it necessary for the user (K) to display the transactions provided by the financial institution and to send request, to the mobile device (2) in the event that the identity authentication unit (4) transmits the information that the user (K) is authenticated. In addition to this, the authentication server (5) also transmits notification to the financial institution unit (3) and maintains the data traffic between the mobile device (2) and the financial institution unit (3).

With the inventive system (1), person authentication transactions independent from recorded data of financial institutions are carried out in order to enable users to use the services provided by arty financial institution. In the said system (1), the authentication server (5) transmits the identity and fingerprint information and/or the retina information and/or the information about the lineament received from the user (K) by means of the mobile device (2), to the identity authentication unit (4) that is ma raged by a higher authority whereon the financial institutions and users depend. The identity authentication unit (4) determines whether the user's (K) identity information and the fingerprint and/or the retina information and/or the information about his/her lineament match or not by comparing the received information with the information of the users recorded by itself. The identity authentication unit (4) transmits the authentication result to the authentication server (5). The authentication server (5) takes action in accordance with the authentication information received. With the inventive system (1), users are enabled to carry out transaction with any financial institution without the users fingerprint information and/or the retina information and/or the information about their lineament being recorded by financial institutions.

It is possible to develop various embodiments of inventive system (1), the invention cannot be limited to examples disclosed herein and it is essentially according to claims.

1. A system (1) providing person authentication by fingerprint and/or retina information and/or face recognition; comprising:
at least one mobile device (2) with which the user (K) interacts, whereon it can run at least one application and which is configured such that the user (K) can read fingerprint and/or read retina information and/or identify lineaments;
at least one financial institution unit (3) which manages the financial institution transactions carried out over Internet, realizes the user (K) authentication, receives the transaction requests of the user (K) who are authenticated, and carries out the transactions in accordance with the related request;
and characterized by:
at least one identity authentication unit (4) which is managed by a competent authority and records the user's fingerprint and/or retina information and/or lineaments in association with their identity information;
at least one authentication server (5) which receives the user (K) requests over the mobile device (2) by means of a data network, transmits the identity information transmitted by the user (K) and the fingerprint read and/or retina information and/or lineaments detected by the mobile device (2) to the identity authentication unit (4) and enables the user (K) to carry out transaction by transmitting the received answer to the financial institution unit (3).

2. A system (1) according to claim 1, characterized by the mobile device (2) which enables the user (K) to display the Internet service belonging to the financial institution, to create inputs and to display the data transmitted by the authentication server (5).

3. A system (1) according to claim 2, characterized by the mobile device (2) which has a structure such that it can read the fingerprint in the event that the user (K) presses his/her finger to a certain area as hardware.

4. A system (1) according to claim 2, characterized by the mobile device (2) which has a structure such that it can read the retina information in the event that the user (K) approaches his/her eye to a certain area as hardware.

5. A system (1) according to claim 2, characterized by the mobile device (2) which has a structure such that lineaments of a user (K) can be detected by leans of an image reception member such as a camera as hardware.

6. A system (1) according to claim 1, characterized by the financial institution unit (3) which receives the transaction demands that the user (K) wants to realize over the authentication server (5) and carries out the transactions in accordance with the transaction demands received, in the event that the authentication server (5) notifies that the user (K) is authenticated.

7. A system (1) according to claim 1, characterized by the identity authentication unit (4) which is a unit wherein the higher authority of the financial institutions, which records users' information about their fingerprints and/or retina information and/or lineaments and their identity information, is provided by the management institution assigned by the state whereon the financial institutions depend by law for the related institutions.

8. A system (1) according to claim 1, characterized by the identity authentication unit (4) which runs query among the user (K) identity information that it records for the user (K) identity information transmitted in the event that the authentication server (5) transmits the identity information that it receives from the user (K) and the user's (K) fingerprint information and/or retina information and/or information about his/her lineament read by means the mobile device (2).

9. A system (1) according to claim 8, characterized by the identity authentication unit (4) which compares the recorded fingerprint information and/or the retina information and/or the information about his/her lineament related to the matched user (K) identity information recorded by itself with the fingerprint information and/or the retina information and/or the information about his/her lineament transmitted by the user (K) via the mobile device (2), in the event that match is provided.

10. A system (1) according to claim 9, characterized by the identity authentication unit (4) which transmits the information that the user (K) is authenticated to the authentication server (5), in the event that the fingerprint information and/or the retina information and/or the information about the lineament match as a result of comparison.

11. A system (1) according to claim 1, characterized by the authentication server (5) which provides integration with the identity authentication unit (4) by using a secure protocol.

12. A system (1) according to claim 11, characterized by the authentication server (5) which informs the user (K) over the mobile device (2) and transmits the interface information, that it necessary the user (K) to display the transactions provided by the financial institution and to send request, to the mobile device (2) in the event that the identity authentication unit (4) transmits the information that the user (K) is authenticated.

13. A system (1) according to claim 12, characterized by the authentication server (5) which also transmits notification to the financial institution unit (3) and maintains the data traffic between the mobile device (2) and the financial institution unit (3).
